(19) United States
(12) Patent Application Publication
(10) Pub. No.: US 2006/0191757 A1
(43) Pub. Date: Aug. 31, 2006

(54) Single cylinder hydraulic shock absorber

(76) Inventor: Shigeru Kojima, Tokyo (JP)

Correspondence Address: RABIN & Berdo, PC, 1101 14TH STREET, NW, SUITE 500, WASHINGTON, DC, 20005, US

(21) Appl. No.: 11/354,110

(22) Filed: Feb. 15, 2006

(30) Foreign Application Priority Data
Feb. 25, 2005 (JP) 2005-49827

(51) Int. Cl. F16F 9/36

(52) U.S. Cl. 188/322.16

(57) ABSTRACT

A first cylindrical member (23) is fitted into an outer periphery of a hydraulic cylinder (1) and supported by a stopper (24). A seal (3) is interposed between the outer periphery of the cylinder (1) and the first cylindrical member (23). A second cylindrical member (22) having a larger diameter than the first cylindrical member (23) is disposed on the outside of the first cylindrical member (23) and connected in an airtight manner to the first cylindrical member (23) by welding. A lower end of a diaphragm (21) is connected in an airtight manner to an outer periphery of the second cylindrical member (22).

### TECHNICAL FIELD OF THE INVENTION

This invention relates to a single cylinder hydraulic shock absorber having an air spring which is used in an air suspension of a vehicle.

### BACKGROUND OF THE INVENTION

JP2004-332747A discloses a single cylinder hydraulic shock absorber comprising an air chamber which functions as an air spring. The air chamber is constituted by a rolling diaphragm. One end of the rolling diaphragm is connected in an airtight manner to a cylinder of the shock absorber, and the other end is connected in an airtight manner to a piston rod which projects from and retract into the cylinder.

### SUMMARY OF THE INVENTION

In this prior art, in order to connect the rolling diaphragm to the cylinder in an airtight manner, a lower end of the rolling diaphragm is connected in an airtight manner to a first cylindrical member, while a lower end of the first cylindrical member is welded in an airtight manner to a lower end of a second cylindrical member having a smaller diameter than the first cylindrical member. Moreover, an upper end of the second cylindrical member is welded in an airtight manner to an outer periphery of the cylinder.

However, with this constitution, depending on the material of the cylinder (when the cylinder is made of aluminum, for example), the strength of the cylinder is reduced by the welding.

It is therefore an object of this invention to ensure the strength of a cylinder in a single cylinder hydraulic shock absorber having an air spring by eliminating welding on the cylinder.

According to this invention, a first cylindrical member is fitted into an outer periphery of a hydraulic cylinder and supported by a stopper. A seal is interposed between the outer periphery of the cylinder and the first cylindrical member. A second cylindrical member having a larger diameter than the first cylindrical member is disposed on the outside of the first cylindrical member and connected in an airtight manner to the first cylindrical member by welding. A lower end of a diaphragm is connected in an airtight manner to an outer periphery of the second cylindrical member.

Embodiments and advantages of this invention will be described in detail below with reference to the attached drawings.

### BRIEF DESCRIPTION OF THE DRAWINGS

FIG. 1 is a partial sectional view of a single cylinder hydraulic shock absorber according to this invention.

FIG. 2 is a sectional view of the main parts of the shock absorber.

### DESCRIPTION OF THE PREFERRED EMBODIMENTS

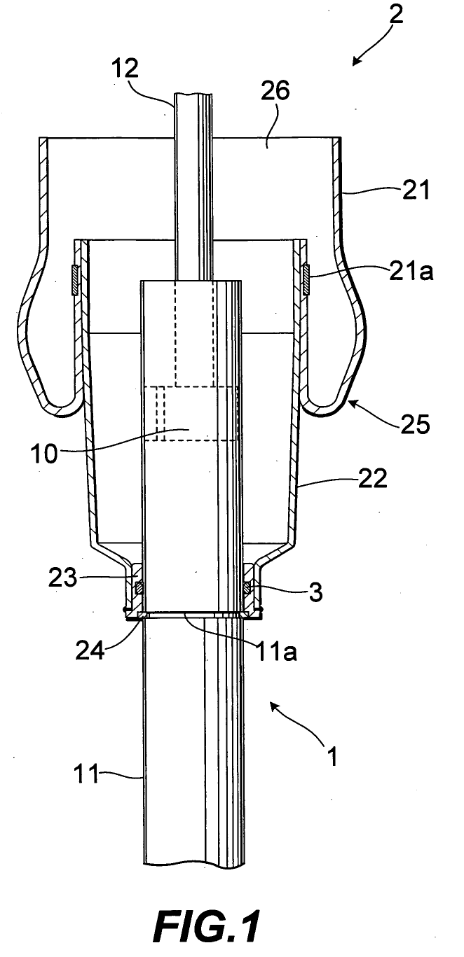

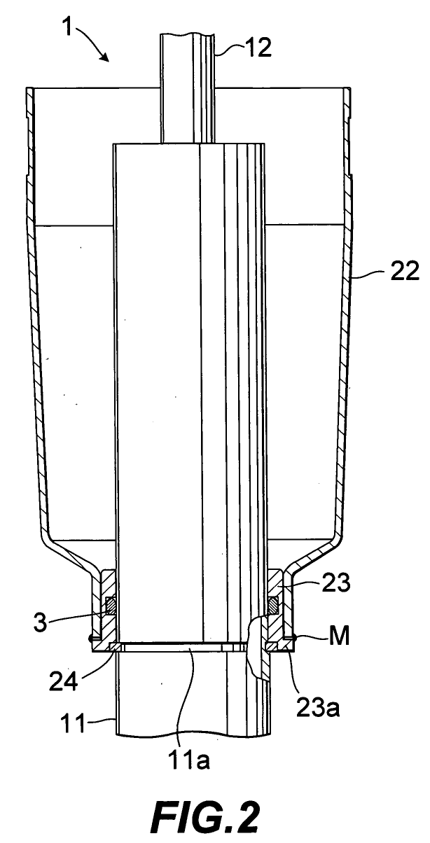

FIGS. 1 and 2 show a single cylinder hydraulic shock absorber according to this invention. A hydraulic cylinder 11 of a shock absorber 1 is made of aluminum. A piston 10 is accommodated inside the cylinder 11, and a piston rod 12 connected to the piston 10 protrudes from and retracts into an upper side of the cylinder 11.

An air chamber 2 functioning as an air spring is provided at an upper side of the shock absorber 1. The air chamber 2 comprises a rolling diaphragm 21 a cylindrical connecting member 22 and an intermediate member 23. The rolling diaphragm 21 is made of an elastic material such as rubber. The cylindrical connecting member 22 and the intermediate member 23 are made of iron or the like and having a predetermined mechanical strength.

The rolling diaphragm 21 takes a cylindrical form having a larger diameter than the cylinder 11 and cylindrical connecting member 22, and comprises a sagging portion 25 which is formed by folding a lower end side of the rolling diaphragm 21 inward. Although not shown in the figure, one end of the rolling diaphragm 21 on the upper side of the figure is connected in an airtight manner to an upper end of the piston rod 12 by arbitrary means. Meanwhile, the other end of the rolling diaphragm 21, which is folded inward at the lower end of the figure, is connected in an airtight manner to an upper end outer periphery of the cylindrical connecting member 22 by a clamping band 21a.

A chamber 26 charged with air is formed on the inside of the rolling diaphragm 21. The volume of the chamber 26 varies as the rolling diaphragm 21 expands and contracts, and as a result, the air chamber 2 generates a predetermined spring reaction.

The cylindrical connecting member 22 decreases in diameter toward the lower side. As described above, the other end of the rolling diaphragm 21 is connected in an airtight manner to the upper end of the cylindrical connecting member 22.

The intermediate member 23 is a cylindrical member having a greater thickness than the cylindrical connecting member 22. A seal 3 is interposed between an inner periphery of the intermediate member 23 and an outer periphery of the cylinder 11 such that airtightness is maintained between the intermediate member 23 and cylinder 11. The seal 3 is accommodated in a groove formed in an inner periphery of the intermediate member 23.

The intermediate member 23 is supported by a stopper 24 provided on the outer periphery of the cylinder 11. The stopper 24 is constituted by a snap ring fitted into a ring shaped groove 11a which is formed in the circumferential direction around the outer periphery of the cylinder 11.

A flange 23a is formed on a lower end of the intermediate member 23. The intermediate member 23 supports the lower end of the cylindrical connecting member 22 by means of the flange 23a. In this state, the lower end of the cylindrical connecting member 22 is welded to the flange 23a in an airtight manner. A symbol M in the figure denotes a welding position.

The single cylinder hydraulic shock absorber according to this invention is constituted as described above such that when the piston rod 12 projects from and retracts into the cylinder 11, the volume of the chamber 26 varies by an amount corresponding to the volume of the piston rod 12 that projects from and retracts into the cylinder 11. As a result, the rolling diaphragm 21 expands and contracts, whereby the air chamber 2 generates a predetermined spring reaction.

Particularly since no welding is performed on the cylinder 11, reductions in the strength of the cylinder 11 caused by welding can be suppressed. Moreover, the constitution of the air chamber 2 has been simplified, and therefore a reduction in the weight of the shock absorber 1 can be achieved, and the weight of the air suspension to which the shock absorber 1 is applied can be suppressed.

Further, the cylindrical connecting member 22 is directly connected to the cylinder 11. As a result, a member (generally formed from iron) for connecting the cylindrical connecting member 22 to the cylinder 11 is not required, and therefore a further reduction in the weight of the shock absorber 1 can be achieved.

Furthermore, a damping force generated when the piston rod 12 projects from and retracts into the cylinder 11 can be raised in accordance with the pressure of the gas that is charged into the chamber 26.

What is claimed is:

1. A single cylinder hydraulic shock absorber comprising:
a hydraulic cylinder;
a rod which projects from and retracts into the cylinder;
a stopper provided on an outer periphery of the cylinder;
a first cylindrical member fitted onto the outer periphery of the cylinder and supported by the stopper;
a seal interposed between the outer periphery of the cylinder and the first cylindrical member;
a second cylindrical member having a greater diameter than the first cylindrical member, which is disposed on an outside of the first cylindrical member and connected in an airtight manner to the first cylindrical member by welding; and
a diaphragm, a lower end of which is connected in an airtight manner to an outer periphery of the second cylindrical member.

2. The shock absorber as defined in claim 1, wherein the first cylindrical member comprises a flange provided on an outer periphery thereof, and
a lower end of the second cylindrical member is supported by the flange and welded to the flange.

3. The shock absorber as defined in claim 1, wherein a ring shaped groove is formed on the outer periphery of the cylinder, and
the stopper is a ring fitted into the ring shaped groove.
